(19) United States
(12) Patent Application Publication
(10) Pub. No.: US 2025/0043756 A1
(43) Pub. Date: Feb. 6, 2025

(54) CANISTER

(71) Applicant: FUTABA INDUSTRIAL CO., LTD., Okazaki-shi (JP)

(72) Inventor: Koji Iwamoto, Okazaki-shi (JP)

(21) Appl. No.: 18/776,553

(22) Filed: Jul. 18, 2024

(30) Foreign Application Priority Data
Jul. 31, 2023 (JP) 2023-124730
Jul. 31, 2023 (JP) 2023-124731
Jul. 31, 2023 (JP) 2023-124732

(51) Int. Cl. F02M 25/08

(52) U.S. Cl. CPC F02M 25/0854

(57) ABSTRACT

One aspect of the present disclosure provides a canister configured to adsorb and desorb fuel vapor generated in a fuel tank of a vehicle. The canister includes a charge port configured to take in the fuel vapor, a purge port configured to release the fuel vapor, an atmosphere port open to an atmosphere, a first adsorption chamber and a second adsorption chamber directly coupled to the charge port and the purge port or indirectly coupled to the charge port and the purge port via an additional chamber, a first adsorption member housed in the first adsorption chamber, and a second adsorption member housed in the second adsorption chamber. The first adsorption member includes a core material and an adsorption sheet having properties to adsorb the fuel vapor and wound around the core material.

### CROSS-REFERENCE TO RELATED APPLICATIONS

The present application claims the benefit of Japanese Patent Application No. 2023-124730, No. 2023-124731, and No. 2023-124732 each filed on Jul. 31, 2023 with the Japan Patent Office, the entire disclosures of which are hereby incorporated by reference herein.

### BACKGROUND

The present disclosure relates to a canister.

A canister that inhibits vapor fuel from being released into the atmosphere is coupled to a fuel tank of a vehicle. The canister adsorbs the vapor fuel to an adsorption member, desorbs fuel from the adsorption member with sucked air for purging, and supplies the purged fuel to an engine of the vehicle.

Known as such an adsorption member of a canister, there is an adsorption member formed by stacking two or more adsorption sheets in layers as disclosed in Japanese Patent No. 7250145. These layers can be also achieved by winding an adsorption sheet.

### SUMMARY

In cases where the adsorption member is made by winding an adsorption sheet as described above, gaps may be created between adjacent layers of the adsorption sheet. Presence of the gaps may allow the fuel vapor to pass through without being adsorbed to the adsorption sheet.

One aspect of the present disclosure preferably provides a canister that can reduce gaps in an adsorption member including a wound adsorption sheet.

An aspect of the present disclosure provides a canister that adsorbs and desorbs fuel vapor generated in a fuel tank of a vehicle. The canister includes: a charge port configured to take in the fuel vapor; a purge port configured to release the fuel vapor; an atmosphere port open to an atmosphere; a first adsorption chamber and a second adsorption chamber directly coupled to the charge port and the purge port, or indirectly coupled to the charge port and the purge port via an additional chamber; a first adsorption member housed in the first adsorption chamber; and a second adsorption member housed in the second adsorption chamber. The first adsorption member includes: a core material; and an adsorption sheet having properties to adsorb the fuel vapor and wound around the core material. Specifically, in the canister, one adsorption chamber of the first adsorption chamber and the second adsorption chamber is directly coupled to the charge port and the purge port, and the other adsorption chamber of the first adsorption chamber and the second adsorption chamber is indirectly coupled to the charge port and the purge port via an additional chamber.

The above-described configuration in which the adsorption sheet is wound around the core material makes it possible to bring adjacent layers of the adsorption sheet into closer contact with each other. This configuration reduces the gaps in the first adsorption member and thus makes it possible to inhibit passage of the fuel vapor.

In the canister described above, the core material may be non-air-permeable. This configuration makes it possible to inhibit passage of the fuel vapor through the core material.

In the canister described above, in the first adsorption chamber, the fuel vapor may flow in an axial direction of the core material. With this configuration, the presence of the core material 71 arranged in the center of the first adsorption member 7 inhibits gas that flows in the first adsorption chamber from concentrating in the center of the first adsorption chamber. Thus, it is possible to spread the flow of the fuel vapor across the first adsorption chamber.

In the canister described above, an outer-circumferential surface of the core material has a cross-section of a shape that may be similar to a shape of a cross-section of an inner-circumferential surface of the first adsorption chamber, the cross-section of the outer-circumferential surface of the core material and the cross-section of the inner-circumferential surface of the first adsorption chamber being perpendicular to the axial direction of the core material. This configuration allows the first adsorption member to be formed in accordance with the shape of the first adsorption chamber, thus improving the degree of design freedom of the first adsorption chamber.

In the canister described above, the core material may include a retaining mechanism retaining a portion of the adsorption sheet. This configuration inhibits displacement of the adsorption sheet during winding of the adsorption sheet and thus makes it possible to bring adjacent layers of the adsorption sheet into closer contact with each other.

In the canister described above, the adsorption sheet may be formed of a fiber having properties to adsorb the fuel vapor. The first adsorption member may further include granules having properties to adsorb the fuel vapor and arranged to be dispersed on a surface of or an inside of the adsorption sheet. In this configuration, a combination of the adsorption capacity of the adsorption sheet and the adsorption capacity of the granules enables the first adsorption member to demonstrate an adsorption effect on fuel vapor in a wide range of concentrations.

In the canister described above, the first adsorption chamber may be directly coupled to the atmosphere port. This configuration enables reduction in leakage of the fuel vapor from the atmosphere port.

### BRIEF DESCRIPTION OF THE DRAWINGS

Example embodiments of the present disclosure will be described hereinafter with reference to the accompanying drawings, in which:

FIG. 1 is a schematic view of a canister according to an embodiment;

FIG. 2A is a schematic perspective view of a first adsorption member in the canister in FIG. 1;

FIG. 2B is a schematic plane view of the first adsorption member in FIG. 2A;

FIG. 3A is a schematic plane view of a first adsorption member according to an embodiment which is different from the embodiment in FIG. 2A;

FIG. 3B is a schematic perspective view of the first adsorption member in FIG. 3A;

FIG. 4A is a schematic perspective view of a core material in the first adsorption member in FIGS. 2A and 2B;

FIG. 4B is a schematic perspective view of the core material in the first adsorption member in FIGS. 2A and 2B;

FIG. 4C is a schematic perspective view of a core material according to an embodiment which is different from the embodiment in FIGS. 4A and 4B;

FIG. 4D is a schematic perspective view of a core material according to an embodiment which is different from the embodiment in FIGS. 4A and 4B;

FIG. 5A is a schematic perspective view of a core material according to an embodiment which is different from the embodiment in FIGS. 4A and 4B;

FIG. 5B is a schematic perspective view of a core material according to an embodiment which is different from the embodiment in FIGS. 4A and 4B;

FIG. 5C is a schematic perspective view of a core material according to an embodiment which is different from the embodiment in FIGS. 4A and 4B;

FIG. 5D is a schematic perspective view of a core material according to an embodiment which is different from the embodiment in FIGS. 4A and 4B;

FIG. 6 is a schematic developed view of an adsorption sheet in the first adsorption member in FIGS. 2A and 2B; and

FIG. 7 is a schematic perspective view of a first adsorption member according to an embodiment which is different from the embodiment in FIGS. 2A and 2B.

### DETAILED DESCRIPTION OF EXEMPLARY EMBODIMENTS

### [1. First Embodiment]

### [1-1. Configuration]

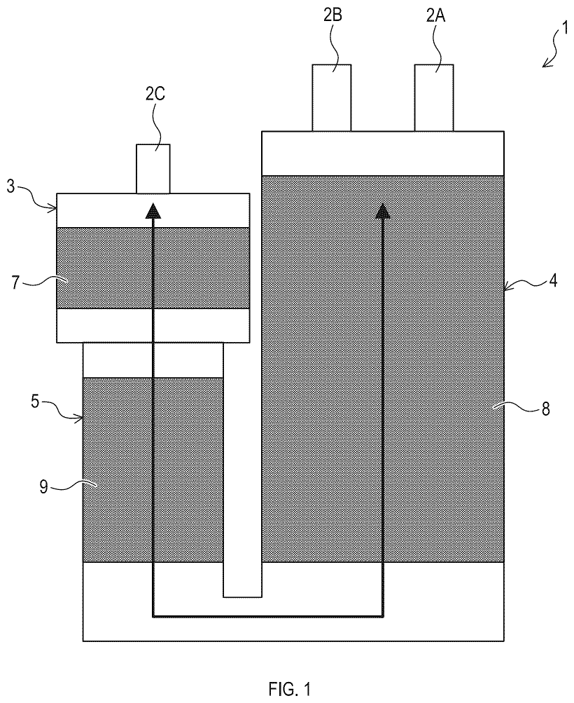

FIG. 1 shows a canister 1 which is a fuel vapor treatment device that adsorbs and desorbs fuel vapor generated in a fuel tank of a vehicle.

The canister 1 includes a charge port 2A, a purge port 2B, an atmosphere port 2C, a first adsorption chamber 3, a second adsorption chamber 4, a third adsorption chamber 5, a first adsorption member 7, a second adsorption member 8, and a third adsorption member 9.

### <Charge Port>

The charge port 2A is coupled to the fuel tank of the vehicle via a pipe. The charge port 2A is configured to take in the fuel vapor generated in the fuel tank to the inside of the canister 1.

### <Purge Port>

The purge port 2B is coupled to an air intake pipe of an engine of the vehicle via a purge valve. The purge port 2B is configured to release, from the canister 1, the fuel vapor in the canister 1 and supply the released fuel vapor to the engine.

### <Atmosphere Port>

The atmosphere port 2C is open to the atmosphere. The atmosphere port 2C releases, to the atmosphere, gas from which the fuel vapor has been removed. The atmosphere port 2C takes in external air (that is, purge air) to desorb (that is, purge) the fuel vapor adsorbed by the canister 1.

### <First Adsorption Chamber>

The first adsorption chamber 3 houses the first adsorption member 7. The first adsorption chamber 3 is directly coupled to the atmosphere port 2C without any other adsorption chamber therebetween. The first adsorption chamber 3 communicates with the atmosphere port 2C and the third adsorption chamber 5. The first adsorption chamber 3 releases, from the atmosphere port 2C, gas from which the fuel vapor has been adsorbed.

### <Second Adsorption Chamber>

The second adsorption chamber 4 houses the second adsorption member 8. The second adsorption chamber 4 is directly coupled to the charge port 2A and the purge port 2B without any other adsorption chamber therebetween. The second adsorption chamber 4 communicates with the charge port 2A, the purge port 2B, and the third adsorption chamber 5. The second adsorption chamber 4 adsorbs the fuel vapor which is taken in from the charge port 2A. The second adsorption chamber 4 releases the adsorbed fuel vapor from the purge port 2B.

### <Third Adsorption Chamber>

The third adsorption chamber 5 houses the third adsorption member 9. The third adsorption chamber 5 is arranged in a flow path of the fuel vapor between the first adsorption chamber 3 and the second adsorption chamber 4.

The fuel vapor taken in from the charge port 2A is adsorbed to the second adsorption member 8 in the second adsorption chamber 4. A portion of the fuel vapor remained un-adsorbed in the second adsorption chamber 4 flows into the third adsorption chamber 5 and is adsorbed to the third adsorption member 9 in the third adsorption chamber 5.

Further, a portion of the fuel vapor remained un-adsorbed in the third adsorption chamber 5 flows into the first adsorption chamber 3 and is adsorbed to the first adsorption member 7 in the first adsorption chamber 3. Gas from which the fuel vapor has been adsorbed is released from the atmosphere port 2C.

The fuel vapor which has been adsorbed to the first to the third adsorption members 7 to 9 respectively in the first to third adsorption chambers 3 to 5 is released to the engine from the purge port 2B as air drawn in from the atmosphere port 2C. Accordingly, air containing the fuel vapor is supplied to the engine.

### <First Adsorption Member>

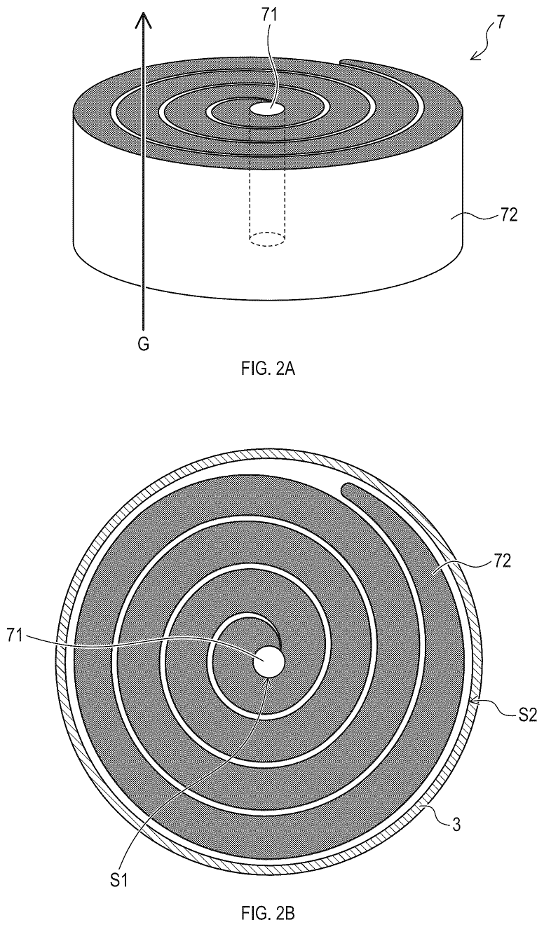

The first adsorption member 7 is housed in the first adsorption chamber 3. As shown in FIGS. 2A and 2B, the first adsorption member 7 includes a core material 71 and an adsorption sheet 72.

### <Core Material>

The core material 71 is a non-air-permeable member in a rod shape. The core material 71 is made of a material with substantially no air-permeability, and has a structure that does not substantially allow passage of gas (in other words, does not have a communication hole or communication space).

The first adsorption member 7 is arranged such that an axial direction of the core material 71 is parallel to a flow direction G of the fuel vapor in the first adsorption chamber 3. In other words, in the first adsorption chamber 3, the fuel vapor flows in the axial direction of the core material 71.

As shown in FIG. 2B, the outer-circumferential surface of the core material 71 has a cross-section, which is perpendicular to the axial direction of the core material 71, in a shape (hereinafter, “first shape”) S1 similar to a shape (hereinafter, “second shape”) S2 of a cross-section of the inner-circumferential surface of the first adsorption chamber 3 perpendicular to the axial direction of the core material 71. In a case, for example, where the second shape S2 of the first adsorption chamber 3 is circular (in other words, in a case where the first adsorption chamber 3 has an internal space of a cylindrical shape), the first shape S1 of the core material 71 is also circular (in other words, the core material 71 also has a cylindrical shape).

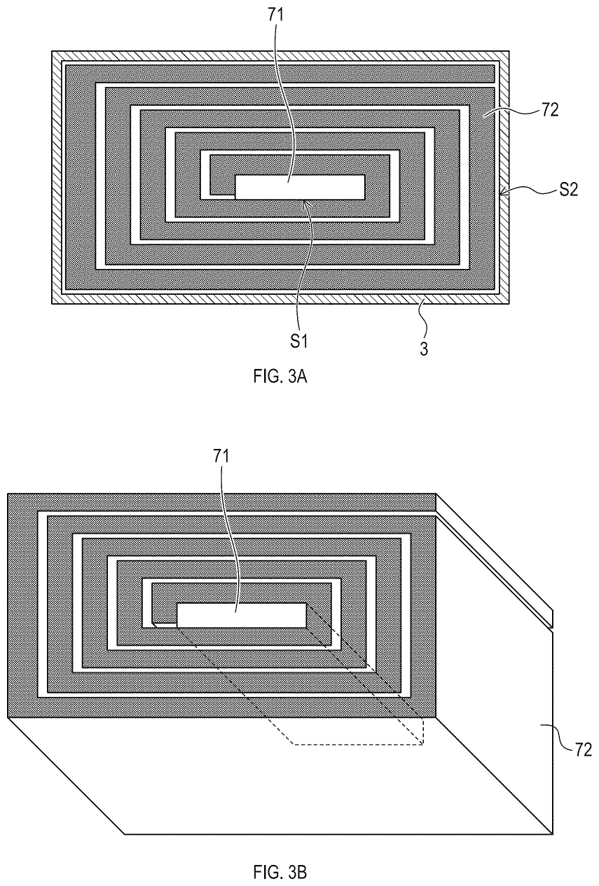

For another example, in a case where, as shown in FIG. 3A, the second shape S2 of the first adsorption chamber 3 is quadrangular (in other words, in a case where the first adsorption chamber 3 has an internal space of a quadrangular prism shape), the first shape S1 of the core material 71 is also quadrangular (in other words, the core material 71 has a quadrangular prism shape as shown in FIG. 3B).

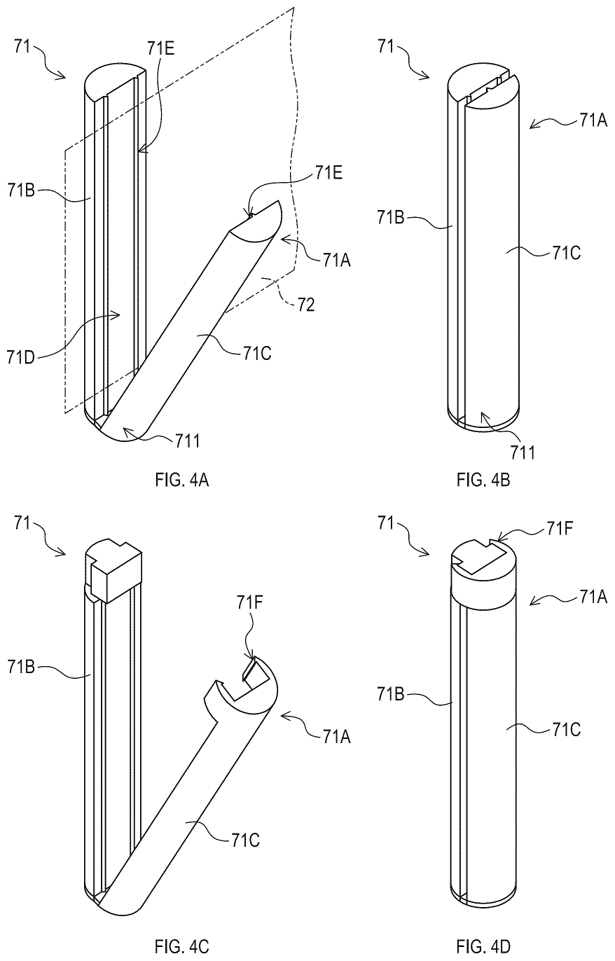

As shown in FIGS. 4A and 4B, the core material 71 includes a retaining mechanism 71A that retains a portion of the adsorption sheet 72. The retaining mechanism 71A includes a base portion 71B and a pressing portion 71C. The base portion 71B and the pressing portion 71C each include a retaining surface 71D on which the adsorption sheet 72 is placed.

The pressing portion 71C is configured to be movable with respect to the base portion 71B. The pressing portion 71C is displaceable between a disengaged position (see FIG. 4A) where the pressing portion 71C is away from the base portion 71B and a retaining position (see FIG. 4B) where the pressing portion 71C and the base portion 71B retain a portion (for example, an end) of the adsorption sheet 72 therebetween. Specifically, the pressing portion 71C is coupled to the base portion 71B at a first end 711 in the axial direction of the core material 71 and thus is pivotable about the first end 711.

The base portion 71B and the pressing portion 71C each include, on a surface in contact with the adsorption sheet 72 (that is, the retaining surface 71D), a protruding/depressed shape 71E that inhibits the adsorption sheet 72 from slipping. An example of the protruding/depressed shape 71E may be a linear protrusion extending in the axial direction of the core material 71.

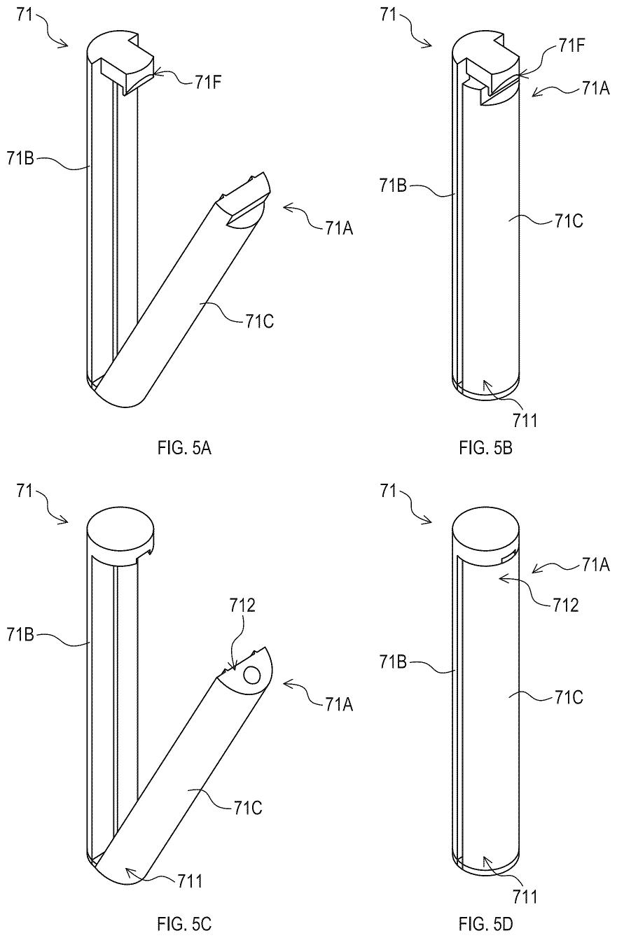

As shown in FIGS. 4C and 4D, or in FIGS. 5A and 5B, the retaining mechanism 71A may include a snap-fit structure 71F that secures the pressing portion 71C at the retaining position to the base portion 71B. As shown in FIGS. 5C and 5D, the pressing portion 71C may be configured such that a second end 712 which is on the opposite side to the first end 711 coupled to the base portion 71B is press-fit to the base portion 71B.

### <Adsorption Sheet>

As shown in FIGS. 2A and 2B, the adsorption sheet 72 is wound around the core material 71. The adsorption sheet 72 has fuel vapor adsorption properties. In other words, the adsorption sheet 72 adsorbs the fuel vapor and butane supplied to the canister 1 together with air and the like. The adsorption sheet 72 desorbs the fuel vapor and butane by introduction of external air.

Specifically, the adsorption sheet 72 is formed of a fiber with fuel vapor adsorption properties. For the adsorption sheet 72, a carbon-fiber woven, knitted, or unwoven fabric, for example, can be preferably used.

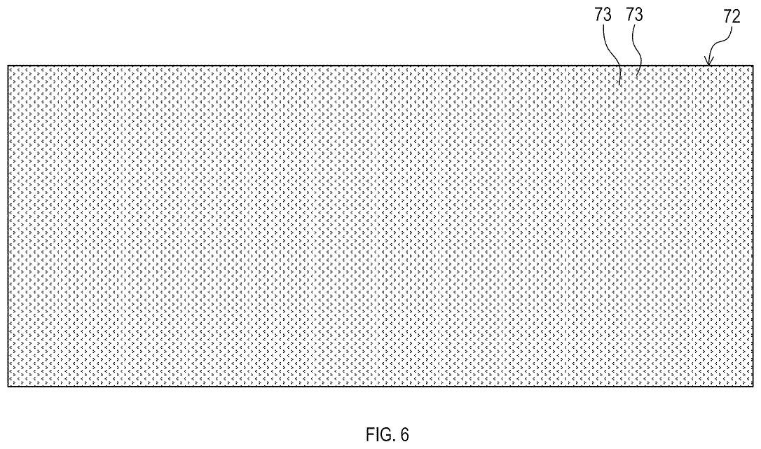

As shown in FIG. 6, the adsorption sheet 72 includes granules 73 arranged to be dispersed on the surface or the inside thereof. The granules 73 have fuel vapor adsorption properties. In other words, the first adsorption member 7 includes the granules 73 having the fuel vapor adsorption properties and arranged to be dispersed on the surface of or the inside of the adsorption sheet 72.

Examples of the granules 73 include activated carbon and zeolite. The granules 73 are positioned inside gaps between fibers (in other words, entangled with fibers) constituting the adsorption sheet 72 and thus held in the adsorption sheet 72. The adsorption sheet 72 is wound around the core material 71 with the granules 73 arranged thereon or therein. The granules 73 are arranged on or in the adsorption sheet 72 by, for example, spraying, coating, or other methods.

The adsorption sheet 72 and the granules 73 have adsorption performances that are different from each other. The adsorption sheet 72 may include two or more types (that is, different from each other in terms of adsorption capacity and/or desorption capacity) of the granules 73 arranged therein/thereon. The adsorption sheet 72 may include a first area in which the granules 73 are arranged and a second area in which the granules 73 are not arranged.

The adsorption sheet 72 is wound around the core material 71, forming two or more cylindrical layers. In other words, the adsorption sheet 72 in a wound state has two or more radially-stacked layers. The layers formed by the adsorption sheet 72 are arranged such that the outer-circumferential surface of inner layers is in contact with the inner-circumferential surface of the outer layers. Accordingly, there is substantially no path inside the wound adsorption sheet 72 for air to pass through in the axial direction of the core material 71.

### <Second Adsorption Member and Third Adsorption Member>

The second adsorption member 8 and the third adsorption member 9 individually adsorb the fuel vapor and butane supplied to the canister 1 together with air and the like. The second adsorption member 8 and the third adsorption member 9 desorb the fuel vapor and butane by introduction of external air.

Examples of materials that can be used for the second adsorption member 8 and the third adsorption member 9 include activated carbon and zeolite. Examples of the activated carbon include aggregates of granular activated carbon adsorbents, activated carbons formed in honeycomb shapes and the like, and fibrous activated carbons formed in sheet shapes, cubic shapes, cylindrical shapes, or polygonal-columnar shapes. The second adsorption member 8 and the third adsorption member 9 may be adsorbents of the same type or of different types. The second adsorption member 8 and the third adsorption member 9 may each include, as with the first adsorption member 7, a core material and an adsorption sheet wound around the core material.

### [1-2. Effect]

According to the embodiment described in detail hereinabove, the following effects can be achieved.

(1a) The configuration in which the adsorption sheet 72 is wound around the core material 71 makes it possible to bring adjacent layers of the adsorption sheet 72 into closer contact with each other. This configuration reduces the gaps of the first adsorption member 7 and thus makes it possible to inhibit passage of the fuel vapor.

(1b) The non-air-permeable core material 71 makes it possible to inhibit passage of the fuel vapor through the core material 71.

(1c) The presence of the core material 71 arranged in the center of the first adsorption member 7 inhibits gas that flows in the first adsorption chamber 3 from concentrating in the center of the first adsorption member 7 when the flow of the fuel vapor in the axial direction of the core material 71. This enables the flow of the fuel vapor to be spread across the first adsorption chamber 3.

(1d) The similarity between the first shape S1 of the core material 71 and the second shape S2 of the first adsorption chamber 3 allows the first adsorption member 7 to be formed in accordance with the shape of the first adsorption chamber 3. This improves the degree of design freedom of the first adsorption chamber 3.

(1e) The core material 71 includes the retaining mechanism 71A, thereby inhibiting displacement of the adsorption sheet 72 during winding of the adsorption sheet 72. This configuration makes it possible to bring adjacent layers of the adsorption sheet 72 into closer contact with each other.

(1f) The first adsorption member 7 includes the granules 73 arranged to be dispersed on/in the adsorption sheet 72. The combination of the adsorption capacity of the adsorption sheet 72 and the adsorption capacity of the granules 73 enables the first adsorption member 7 to demonstrate an adsorption effect on fuel vapor in a wide range of concentrations.

(1g) The configuration in which the first adsorption member 7 is housed in the first adsorption chamber 3 coupled to the atmosphere port 2C enables reduction in leakage of the fuel vapor from the atmosphere port 2C.

### [2. Other Embodiments]

An embodiment of the present disclosure has been described hereinabove. However, it goes without saying that the present disclosure is not limited to the aforementioned embodiment and may be embodied in various forms.

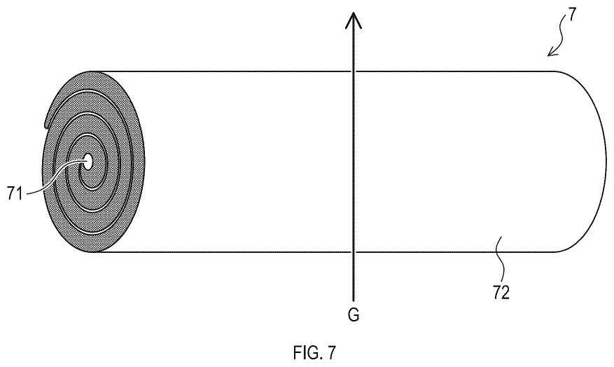

(2a) In the canister of the aforementioned embodiment, in the first adsorption chamber the fuel vapor does not necessarily have to flow in the axial direction of the core material. For example, as shown in FIG. 7, the first adsorption member 7 may be arranged such that the axial direction of the core material 71 intersects with the flow direction G of the fuel vapor in the first adsorption chamber. In this case, the core material 71 may have a hollow shape (in other words, a hollow cylindrical shape).

(2b) In the canister of the aforementioned embodiment, the core material does not necessarily include the retaining mechanism that retains the adsorption sheet. The adsorption sheet may be secured to the core material using a securing means such as an adhesive. A wound body of the adsorption sheet may be placed in an adsorption chamber, and then the core material may be inserted in the wound body.

(2c) In the canister of the aforementioned embodiment, the first adsorption member does not have to necessarily include the granules. The material of the adsorption sheet only needs to be air-permeable and adsorptive, and thus is not limited to fiber.

(2d) In the canister of the aforementioned embodiment, the first adsorption member does not necessarily have to be housed in the first adsorption chamber coupled to the atmosphere port. The first adsorption member may be housed in, for example, an adsorption chamber coupled to a charge port and a purge port.

(2e) One or a plurality of functions of one component in the aforementioned embodiments may be distributed as a plurality of components, or one or a plurality of functions of a plurality of components may be integrated into one component. A part of the configurations of the above embodiments may be omitted. At least a part of the configurations of the above embodiments may be added to or replaced with another configuration of the above embodiments. Any and all embodiments encompassed by the technical idea defined by the language of the claims are embodiments of the present disclosure.

What is claimed is:

1. A canister configured to adsorb and desorb fuel vapor generated in a fuel tank of a vehicle, the canister comprising:
a charge port configured to take in the fuel vapor;
a purge port configured to release the fuel vapor;
an atmosphere port open to an atmosphere;
a first adsorption chamber and a second adsorption chamber directly coupled to the charge port and the purge port, or indirectly coupled to the charge port and the purge port via an additional chamber;
a first adsorption member housed in the first adsorption chamber; and
a second adsorption member housed in the second adsorption chamber,
the first adsorption member including:
a core material; and
an adsorption sheet having properties to adsorb the fuel vapor and wound around the core material.

2. The canister according to claim 1, wherein the core material is non-air-permeable.

3. The canister according to claim 2, wherein, in the first adsorption chamber, the fuel vapor flows in an axial direction of the core material.

4. The canister according to claim 1, wherein an outer-circumferential surface of the core material has a cross-section of a shape similar to a shape of a cross-section of an inner-circumferential surface of the first adsorption chamber, the cross-section of the outer-circumferential surface of the core material and the cross-section of the inner-circumferential surface of the first adsorption chamber being perpendicular to an axial direction of the core material.

5. The canister according to claim 1, wherein the core material includes a retaining mechanism retaining a portion of the adsorption sheet.

6. The canister according to claim 1,
wherein the adsorption sheet is formed of a fiber having properties to adsorb the fuel vapor, and
wherein the first adsorption member further includes granules having properties to adsorb the fuel vapor and arranged to be dispersed on a surface of or an inside of the adsorption sheet.

7. The canister according to claim 1, wherein the first adsorption chamber is directly coupled to the atmosphere port.

8. The canister according to claim 2, wherein an outer-circumferential surface of the core material has a cross-section of a shape similar to a shape of a cross-section of an inner-circumferential surface of the first adsorption chamber, the cross-section of the outer-circumferential surface of the core material and the cross-section of the inner-circumferential surface of the first adsorption chamber being perpendicular to an axial direction of the core material.

9. The canister according to claim 2, wherein the core material includes a retaining mechanism retaining a portion of the adsorption sheet.

10. The canister according to claim 2,
wherein the adsorption sheet is formed of a fiber having properties to adsorb the fuel vapor, and
wherein the first adsorption member further includes granules having properties to adsorb the fuel vapor and arranged to be dispersed on a surface of or an inside of the adsorption sheet.

11. The canister according to claim 2. wherein the first adsorption chamber is directly coupled to the atmosphere port.
